(19) United States
(12) Patent Application Publication
(10) Pub. No.: US 2024/0179532 A1
(43) Pub. Date: May 30, 2024

(54) Privacy Preserving Bluetooth Low Energy Pairing

(71) Applicant: Apple Inc., Cupertino, CA (US)

(72) Inventors: Chen GANIR, San Jose, CA (US); Yann LY-GAGNON, San Francisco, CA (US); Anjali S. SANDESARA, Sunnyvale, CA (US); Lochan VERMA, Danville, CA (US)

(21) Appl. No.: 18/502,182

(22) Filed: Nov. 6, 2023

Related U.S. Application Data
(60) Provisional application No. 63/385,528, filed on Nov. 30, 2022.

(51) Int. Cl. H04W 12/50; H04W 12/041; H04W 12/69

(52) U.S. Cl. CPC H04W 12/50; H04W 12/041; H04W 12/69

(57) ABSTRACT

A wireless device configured to transmit a pairing request message to an accessory device, decode, based on signals received from the accessory device, a pairing response message, establish a connection with the accessory device, decode, based on signals received from the accessory device, information identifying the accessory device, generate an identity resolving key (IRK) uniquely associated with the accessory device and a long-term key (LTK) associated with the accessory device and store the IRK and the LTK.

### PRIORITY/INCORPORATION BY REFERENCE

This application claims priority to U.S. Provisional Application Ser. No. 63/385,528 filed on Nov. 30, 2022 and entitled, “Privacy Preserving Bluetooth Low Energy Pairing,” the entirety of which is incorporated herein by reference.

### BACKGROUND

Privacy is a key concern in pairing user equipment (UEs) to third party accessories via Bluetooth Low Energy (BT LE). Consumer use of smart home devices continues to grow, especially in view of recent industry-wide alignment around subject matter standards. Many of these accessories may connect to a UE via BT LE. Currently, a UE pairing to a third party accessory must share the UE identity resolving key (IRK).

Sharing of the IRK allows third party accessories to track the UE and resolve the UE identity (because the UE has been paired). If the third party device or service (upstream of the device) is compromised, the third party device may share the UE IRK to another device, allowing another device to track the UE.

### SUMMARY

Some example embodiments are related to an apparatus of a wireless device, the apparatus including processing circuitry configured to configure transceiver circuitry to transmit a pairing request message to an accessory device, decode, based on signals received from the accessory device, a pairing response message, establish a connection with the accessory device, decode, based on signals received from the accessory device, information identifying the accessory device, generate an identity resolving key (IRK) uniquely associated with the accessory device and a long-term key (LTK) associated with the accessory device and store the IRK and the LTK.

Other example embodiments are related to a method performed by a wireless device. The method includes transmitting a pairing request message to an accessory device, receiving a pairing response message from the accessory device, establishing a connection with the accessory device, receiving information identifying the accessory device, generating an identity resolving key (IRK) uniquely associated with the accessory device and a long-term key (LTK) associated with the accessory device and storing the IRK and the LTK.

### BRIEF DESCRIPTION OF THE DRAWINGS

FIG. 1 shows an example system of components utilizing short-range communication links according to various example embodiments.

FIG. 2 shows an example UE according to various example embodiments.

FIG. 3 shows a call diagram for initial BT LE pairing

according to various example embodiments.

FIG. 4 shows a call diagram for UE reconnection to a previously paired accessory according to various example embodiments.

FIG. 5 shows a call diagram for UE unpairing from a paired accessory device according to various example embodiments.

### DETAILED DESCRIPTION

The example embodiments may be further understood with reference to the following description and the related appended drawings, wherein like elements are provided with the same reference numerals. The example embodiments relate to privacy-preserving BT LE pairing to third party accessories.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component, e.g., any wireless device.

The example embodiments are described herein with regard to establishing a short-range communication link (or connection) where the short-range communication link is a Bluetooth Low Energy (BT LE) link. However, the use of the BT LE link is only example and the BT LE link may represent (or be replaced by) any short-range communication link where the UE will share an identity with an accessory device for the purposes of pairing with the accessory device. Furthermore, the use of a short-range communication link is also only example and the example embodiments may be used or modified for any type of connection between two or more devices (e.g., a medium- or long-range connection).

The example embodiments are described herein with regard to the BT LE link being established between an accessory device and a UE. However, the use of this accessory device and UE configuration is only example and the example embodiments may be used or modified for any two or more devices that are to establish a connection using the mechanism described herein. That is, there is no requirement that one of the devices be subordinate to the other device. The use of the terms UE and accessory device are only for the convenience of distinguishing between the two devices in this description.

The example embodiments are also described with reference to a device IRK and an accessory IRK. The device IRK is the IRK assigned to the device (e.g., UE) and the identity that the device will use for BT advertising, e.g., the IRK used to generate a resolvable address that is included in the BT advertising performed by the device. The accessory IRK is a specially generated IRK that is only shared with one particular device and is only used for pairing or other operations with that one particular device.

The consumer electronics space has featured numerous competing standards for smart home devices over the past several years. These competing standards are likely to have discouraged consumer investment in any particular format out of hesitancy to financially commit to a potential technological cul-de-sac. Subject matter standards (and corresponding industry adoption) will likely lead to large consumer uptake in interoperable Matter-compliant smart home devices.

Consumer privacy protection is paramount when connecting to any smart home device. History has shown third party smart home accessories often have varying degrees of security and software maintenance by their manufacturers. One potential avenue for private information to leak is through a compromised Bluetooth device. One particularly high-risk use case are smart locks. These smart locks are likely to proliferate in homes, hotels, and vehicles in the coming decade.

Typically, a UE shares its identity resolving key (IRK) with a Bluetooth accessory during connection procedures. The IRK uniquely identifies the UE to the Bluetooth accessory and allows the accessory to track a paired UE. Current BT LE pairing operations require a UE to share its IRK and a long-term key (LTK), which the UE may also use for advertisement. Should the accessory be compromised, however, the accessory may share the UE IRK with another accessory to enable discrete tracking of the UE.

The example embodiments relate to generating an accessory IRK that is unique to each third party accessory with which the UE pairs. The example embodiments do not pertain to UE advertising. That is, the accessory IRK is not freely advertised. Rather, the UE generates a unique accessory IRK in response to receiving an accessory advertisement. The UE may resolve the accessory advertisement and respond with a Bluetooth CONNECT_IND message with a unique random resolvable address (RRA) generated with an accessory IRK for the accessory. These operations may be performed in the UE firmware layer to minimize power consumption and avoid unnecessary application processor wake operations. Use of unique accessory IRKs limits the impact of a compromised Bluetooth accessory because no additional accessories will learn the device IRK of the UE.

The operations of the example embodiments may be enhanced by addition of a geofencing scheme. Use of such a scheme may be desirable for third party accessories that are stationary (such as a smart lock). The UE may only reply with a CONNECT_IND in a known location (such as a home address or a hotel address).

The operations of the example embodiments may be further modified by use of received signal strength indicator (RSSI) measurements. A UE may only reply to an accessory (such as a smart lock) that are spatially nearby the UE. The operations of the example embodiments may utilize combinations of the aforementioned conditions (or additional conditions, such as UE motion).

The example embodiments exist as additional-UE side operations on top of Bluetooth LE protocols. From the perspective of a third party accessory, nothing is changed (the accessory does not know that the IRK is generated specifically for the accessory). The example embodiments permit a UE to never share its device IRK with third party accessories. Another advantage of the example embodiments is that if an accessory fails to remove the UE IRK after an unpairing procedure (i.e., failing to comply with Bluetooth standards), the accessory cannot track the UE because it only has the accessory IRK. Another advantage is avoidance of passive tracking of the UE by only sending the CONNECT_IND if the accessory is nearby by validating the RSSI.

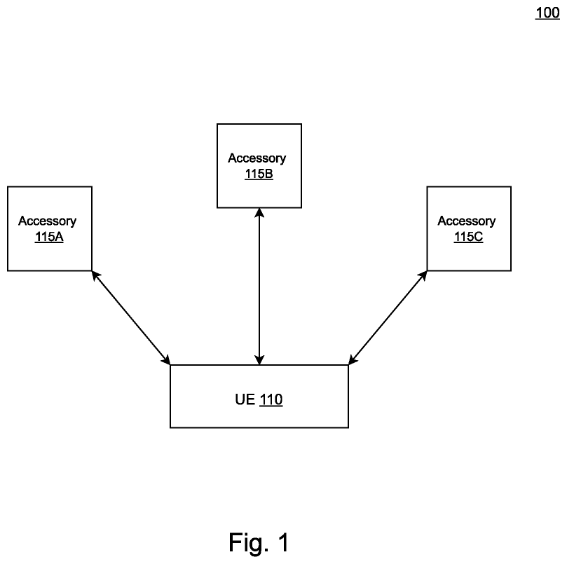

FIG. 1 shows an example network 100 of components utilizing short-range communication links according to various example embodiments. The network 100 illustrates a possible network of short-range connections between a UE 110 and one or more accessories 115A, 115B, and 115C. It should be understood that the three accessories 115A-C are only example. The UE 110 may generate unique accessory IRKs for each accessory 115A-C with which it pairs. While the example embodiments are described with reference to the accessory devices 115A-115C being smart locks, the accessory devices 115A-115C may be any Bluetooth LE device, including, for example, wearables, audio output devices, health sensors, proximity tags, vehicles, etc. One of skill in the art will recognize the utility of accessory IRKs across the range of possible Bluetooth LE devices.

As described above, in conventional circumstances, when the UE 110 pairs with any one of the accessory devices 115A-115C, the UE 110 will share its device IRK, e.g., by using the IRK to generate a resolvable address that can be resolved by other devices that have access to the IRK. Thus, each of the accessory devices 115A-115C will have the IRK of the UE 110. If one or more of the accessory devices become compromised, the device or person that has comprised the accessory device 115A-115C will know the device IRK of the UE 110 and may be able to track the UE 110.

In contrast, in the example embodiments, when the UE 110 pairs with any one of the accessory devices 115A-115C, the UE 110 will share a randomly generated accessory IRK. Each accessory device 115A-115C to which the UE 110 pairs will have an IRK for the UE 110, but that IRK will not be the device IRK. Thus, if one of the accessory devices 115A-115C is compromised, the device or person that has compromised the accessory device 115A-115C will only know the singular accessory IRK shared by the UE 110 for the individual accessory device 115A-115C that was compromised. Since the UE 110 will not advertise this accessory IRK, the compromised accessory IRK cannot be used to track the UE 110.

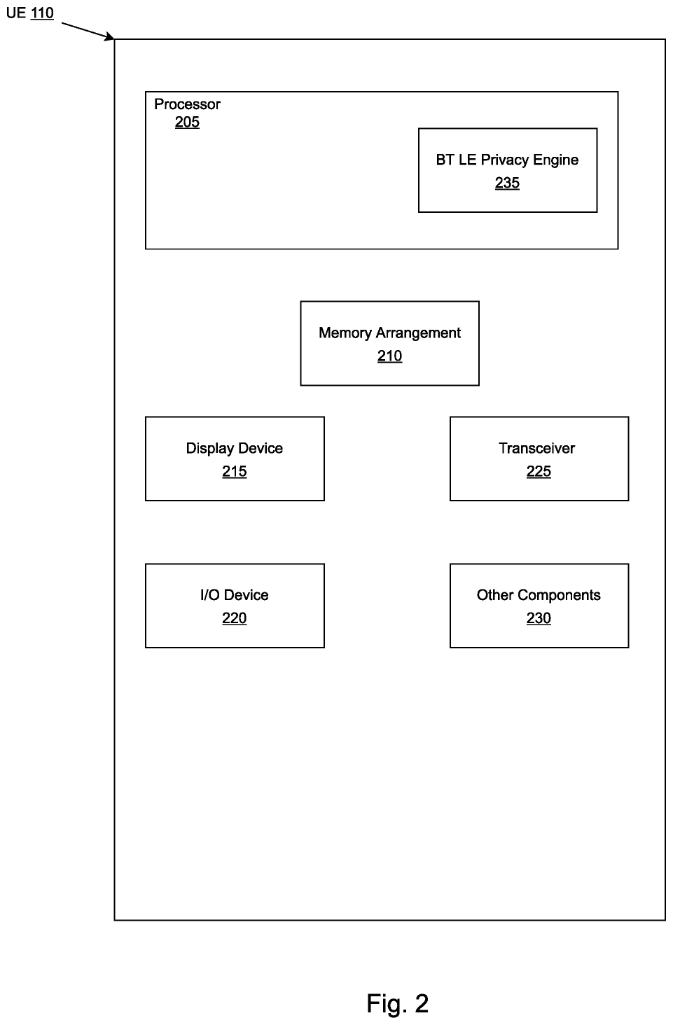

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a BT LE privacy engine 235 for performing operations such as generating accessory IRKs/LTKs and evaluating conditions relevant to pairing such as RSSI, device motion, and geofencing.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with an accessory device. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

The UE 110 may be a wireless device used for establishing a short-range communication link and performing operations to generate accessory IRKs according to the example embodiments. Specifically, the UE 110 may represent the components that may be included to perform the operations according to the example embodiments.

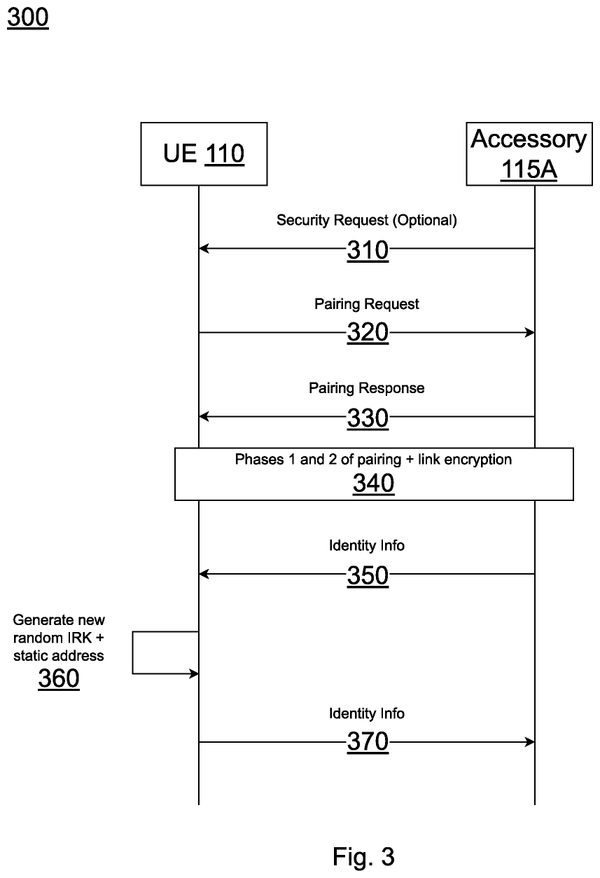

FIG. 3 shows a call diagram 300 for initial BT LE pairing according to various example embodiments. The operations of call diagram may be understood to occur between the UE 110 and accessory 115A, though the accessory 115A is only example, e.g., the UE 110 may perform the operations of call diagram 300 with any BT LE device, such as the accessories 115B and 115C.

The example embodiments generally relate to situations in which the UE 110 is responding to an accessory, e.g., the accessory 115A is performing an advertising operation and the UE 110 identifies the accessory device 115A using a BT LE scan operation. In another example, as shown in 310 of FIG. 3, the accessory 115A may send an optional security request to initiate pairing. The operation 310 is described as optional because the security request is a Bluetooth specific manner for a peer to initiate pairing or encryption. The security request assumes that the connection between the devices is already active at this point.

In 320, the UE 110 sends a pairing request to the accessory 115A. The pairing request 320 elicits a pairing response 330 that is sent from the accessory 115A to the UE 110. In 340, the UE 110 and the accessory 115A perform phases 1 and 2 of pairing and encrypt the connection link. Those skilled in the art will understand the phase 1 and phase 2 operations of the BT LE pairing procedure.

In 350, the accessory 115A transmits identity information to the UE 110. In 360, the UE 110 generates a new random accessory IRK and LTK associated specifically with the accessory 115A (and not, for example, with accessories 115B-C). The UE 110 stores the newly generated IRK and LTK for future use with the accessory 115A.

In 370, the UE 110 transmits its identity information to the accessory 115A. The identity information includes the newly generated accessory IRK. The accessory 115A is now satisfied that the BT LE connection is complete, without awareness it has received an IRK that is not the device IRK from the UE 110. If the accessory 115A is compromised, it only has the accessory IRK specific for the accessory 115A, minimizing potential exposure of user data.

After successful pairing with an accessory (e.g., accessory 115A), the UE 110 may then add the accessory 115A to a filter accept list stored on the UE 110. In some example embodiments, the filter accept list may also include a condition for reconnection, e.g., RSSI threshold. The use of the filter accept list (including the condition) will be described in greater detail below when describing when the UE 110 reconnects to a known accessory.

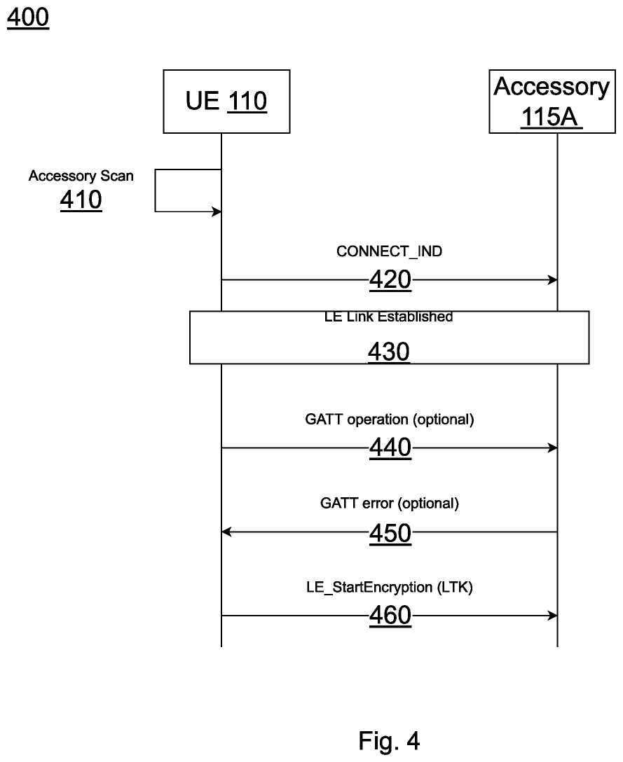

FIG. 4 shows a call diagram 400 for the UE 110 reconnection to a previously paired accessory according to various example embodiments. As described above, the call diagram 300 shows operations for initial pairing between the UE 110 and the accessory 115A. When this initial pairing process is complete, the UE 110 and the accessory 115A have information that allows for a faster reconnection when the devices want to pair in the future. Such reconnection procedures occur often with smart home devices, such as a smart door lock, which a user may interact with multiple times per day. Thus, the call diagram 400 shows an example of when the UE 110 reconnects with the accessory device 115A.

At 410, the UE 110 performs an accessory scan (e.g., a BT LE scan). In this example, it may be considered that the UE 110 identifies the accessory 115A using the scan. As described above, since the UE 110 previously connected to the accessory 115A, the accessory 115A will be included on the filter accept list stored on the UE 110. Again, in this example, the filter accept list may include a condition for the accessory 115A, which is a RSSI with a predefined threshold. The predefined threshold ensures that the UE 110 will only proceed to attempt to connect to the accessory 115A if the RSSI threshold is satisfied. To provide an example, if the accessory 115A is a door lock, the RSSI threshold may be set such that the UE 110 is within a certain distance from the door lock. This may avoid the UE 110 from attempting to connect to spoofed accessory that is advertising the identity of the accessory 115A.

When the UE 110 identifies the accessory 115A and the condition is satisfied, the UE 110 (e.g., the BT controller of the UE 110) will generate a random resolvable address (RRA) from the associated IRK for the accessory 115A, e.g., the IRK stored at operation 360 in FIG. 3. In 420, the UE 110 transmits a CONNECT_IND message to the accessory 115A, including the newly generated RRA. As described above, these operations may be performed by the BT controller of the UE 110 without the need for the application processor to be awake.

In 430, the BT LE link is established using the normal BT process and the information included in the CONNECT_IND message.

The operations 440 and 450 may be performed if the UE 110 does not immediately encrypt the BT LE link established in 430. In 440 the UE 110 transmits a Generic Attribute Profile (GATT) to the accessory 115A in response to the UE 110 failing to immediately encrypt the BT LE link. In 450, the accessory 115A transmits a GATT error message to the UE 110 indicating that the BT LE link established in 430 is insufficiently encrypted.

At 460, the UE 110 transmits a LE_StartEncryption message to the accessory 115A. The message 460 includes a LTK that has been previously established between the UE 110 and the accessory 115A (e.g., as described above, FIG. 4 depicts a reconnection procedure, so the LTK is already known and stored).

In the example described above, the condition was an RSSI threshold. However, other conditions may be used. For example, the condition (s) may also include geo-fencing, motion, etc. To provide an example, the UE 110 may be provided with the geo-fencing information for the accessory 115A, if the UE 110 is not within the location parameters of the geo-fencing, the UE 110 will not attempt to connect with the accessory 115A. The condition may also be a combination of factors, e.g., within the geo-fencing and not in a motion condition.

In other example embodiments, the UE 110 may have multiple IRKs stored for an accessory (e.g., the accessory 115A). Each of the multiple IRKs may be associated with a singular condition (e.g., motion, geo-fencing, RSSI, etc.).

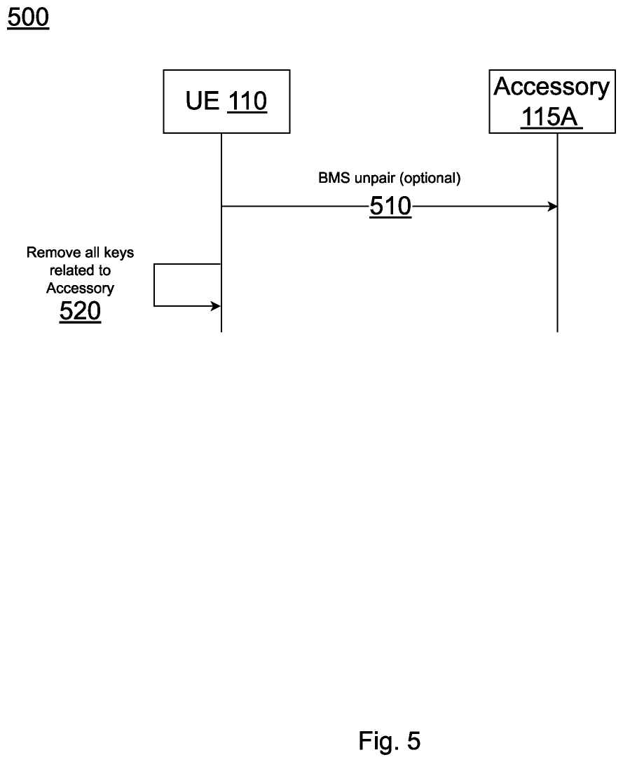

FIG. 5 shows a call diagram for UE unpairing from a paired accessory device according to various example embodiments. Operation 510 is optional and pertains to situations in which the UE 110 is actively connected to the Accessory 115A. The UE 110 may transmit a Bond Management Service (BMS) unpair message to the accessory 115A. The accessory 115A then proceeds to follow standard Bluetooth unpair operations including removing the UE 110 IRK and the LTK associated with the UE 110.

In 520, the UE 110 (regardless of if the BMS unpair message was transmitted in 520), the UE 110 removes all keys related to the accessory 115A, including the IRK associated with the accessory 115A and the LTK. These operations ensure that on the next pairing of the UE 110 and the accessory 115A that the UE 110 generates a new IRK and LTK. This also ensures that even if the accessory 115A is not compliant and fails to flush the UE 110 keys in 510, there is no leak of user data.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a wireless device, comprising:
transmitting a pairing request message to an accessory device;
receiving a pairing response message from the accessory device;
establishing a connection with the accessory device;
receiving information identifying the accessory device;
generating an identity resolving key (IRK) uniquely associated with the accessory device and a long-term key (LTK) associated with the accessory device; and
storing the IRK and the LTK.

2. The method of claim 1, further comprising:
transmitting a message identifying the wireless device to the accessory device, the message comprising the IRK.

3. The method of claim 1, wherein the pairing request message and the pairing response message are exchanged using a Bluetooth Low Energy (BT LE) protocol and the connection is a BT LE connection.

4. The method of claim 1, further comprising:
disconnecting from the accessory device.
identifying the accessory device based on a scan;
determining the accessory device is on a filter accept list;
determining a condition associated with the accessory device is satisfied;
generating a random resolvable address (RRA) based on the IRK uniquely associated with the accessory device;
transmitting a connection indication message comprising the RRA to the accessory device; and
reconnecting the connection with the accessory device.

5. The operations of claim 4, further comprising:
transmitting a generic attribute profile (GATT) message to the accessory device; and
receiving a GATT error message from the accessory, the GATT error message comprising an indication of insufficient encryption of the connection.

6. The method of claim 5, further comprising:
encrypting the connection between the wireless device and the accessory device, wherein the encryption is based on the LTK.

7. The method of claim 4, wherein the condition comprises at least one of (i) a motion state of the wireless device, (ii) a received signal strength indicator (RSSI) threshold, or (iii) a geo-fenced area.

8. The method of claim 4, wherein the condition is associated with the IRK uniquely associated with the accessory device.

9. The method of claim 8, wherein the IRK comprises a plurality of IRKs, wherein each of the plurality of IRKs is associated with a corresponding condition.

10. The method of claim 1, further comprising:
deleting the IRK and LTK associated with the accessory device.

11. The method of claim 1, further comprising:
transmitting an unpair message to the accessory device.

12. An apparatus of a wireless device, the apparatus comprising processing circuitry configured to:
configure transceiver circuitry to transmit a pairing request message to an accessory device;
decode, based on signals received from the accessory device, a pairing response message;
establish a connection with the accessory device;
decode, based on signals received from the accessory device, information identifying the accessory device;
generate an identity resolving key (IRK) uniquely associated with the accessory device and a long-term key (LTK) associated with the accessory device; and
store the IRK and the LTK.

13. The apparatus of claim 12, wherein the processing circuitry is further configured to:
configure transceiver circuitry to transmit a message identifying the wireless device to the accessory device, the message comprising the IRK.

14. The apparatus of claim 12, wherein the pairing request message and pairing response message are exchanged using a Bluetooth Low Energy (BT LE) protocol and the connection is a BT LE connection.

15. The apparatus of claim 12, wherein the processing circuitry is further configured to:
disconnect from the accessory device;
identify the accessory device based on a scan;
determine the accessory device is on a filter accept list;
determine a condition associated with the accessory device is satisfied;
generate a random resolvable address (RRA) based on the IRK uniquely associated with the accessory device;
configure transceiver circuitry to transmit a connection indication message comprising the RRA to the accessory device; and
reconnect the connection with the accessory device.

16. The apparatus of claim 15, wherein the processing circuitry is further configured to:
configure transceiver circuitry to transmit a generic attribute profile (GATT) message to the accessory device; and
decode, based on signals received from the accessory device, a GATT error message comprising an indication of insufficient encryption of the connection.

17. The apparatus of claim 16, wherein the processing circuitry is further configured to:
encrypt the connection between the wireless device and the accessory device, wherein the encryption is based on the LTK.

18. The apparatus of claim 15, wherein the condition comprises (i) a motion state of the wireless device, (ii) a received signal strength indicator (RSSI) threshold, or (iii) a geo-fenced area.

19. The apparatus of claim 15, wherein the condition is associated with the IRK uniquely associated with the accessory device.

20. The apparatus of claim 19, wherein the IRK comprises a plurality of IRKs, wherein each of the plurality of IRKs is associated with a corresponding condition.
